(19) United States
(12) Patent Application Publication
(10) Pub. No.: US 2019/0264517 A1
(43) Pub. Date: Aug. 29, 2019

(54) INTEGRATED FLUIDS DELIVERY PLATFORM

(71) Applicant: Schlumberger Technology Corporation, Sugar Land, TX (US)

(72) Inventors: Jonathan Wun Shiung Chong, Houston, TX (US); Andrew Marlatt, Richmond, TX (US); Franz Aguirre, Sugar Land, TX (US); Kevin Kennett, Katy, TX (US)

(21) Appl. No.: 15/905,277

(22) Filed: Feb. 26, 2018

(51) Int. Cl. E21B 21/06; B01F 15/02; B01F 13/00; B01F 15/00; B01F 13/10; B01F 7/18; B01F 7/22; B01F 3/12; E21B 33/14

(52) U.S. Cl. CPC E21B 21/062; E21B 21/08; B01F 13/0045; B01F 13/004; B01F 15/00025; B01F 15/0283; B01F 15/00422; B01F 15/00142; B01F 13/1016; B01F 7/18; B01F 7/22; B01F 3/1221; E21B 33/14; B01F 2215/0081; B01F 15/0243

(57) ABSTRACT

A fluids delivery system may include a mixing system configured to deliver a fluid to a wellbore; a dry component delivery system configured to deliver a dry component to the mixing system; a liquid additive system configured to deliver a liquid component to the mixing system; and a controls system configured to control the mixing system, the dry additive system and the liquid additive system to produce the fluid.

### BACKGROUND

Exploring, drilling, and completing hydrocarbon wells are generally complicated, time consuming and ultimately very expensive endeavors. This may be especially true in the case of certain drilling and completion operations where the configuration or environment of the operation or production site presents added challenges.

In certain drilling operations, the operating environment may pose several natural challenges dramatically affecting the expense of operations. In the case of land drilling, measures are often taken to curtail expenses such as keeping equipment and space for equipment to a minimum. That is, for a given land operation, any increase in the amount or types of equipment required, as well as the necessary accommodations, comes with a fairly dramatic increase in land set up and operating expenses. In certain circumstances expenses may be saved by limiting the equipment employed. However, even with certain sacrifices made in terms of equipment choices, redundancy and maximum equipment usage is desired in land operations.

Like most drilling rigs, a land rig generally includes both a mud pumping assembly and a cement pumping assembly along with a host of other drilling equipment. These assemblies, in particular, are alternatingly employed in completing an underground well and providing a casing therefor. That is, as a drill bit is advanced downward to form and extend a borehole below ground, the mud pumping assembly is employed to both provide fluid and remove debris with respect to a location near the advancing bit. Once the borehole has been drilled to the desired depth by the drill bit, mud circulation is temporarily stopped with the drill bit and associated drilling pipe brought back to the surface. A section of borehole casing may then be advanced down into the borehole. Once the borehole casing is properly positioned and the mud circulation terminated, the cement pumping assembly may be operated to pump a cement slurry through the borehole, securing the borehole casing in place. This process may then be repeated until a well of the desired depth has been completed. That is, further drilling, mud circulation, and advancing of additional borehole casing, may continue, periodically interrupted by subsequent cementing and securing of the casing as described. Each system has had its equipment separately maintained and isolated given the potential catastrophic consequences of cement slurry or mud contamination at the improper stage of completion.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a fluids delivery system that includes a mixing system configured to deliver a fluid to a wellbore; a dry component delivery system configured to deliver a dry component to the mixing system; a liquid additive system configured to deliver a liquid component to the mixing system; and a controls system configured to control the mixing system, the dry additive system and the liquid additive system to produce the fluid.

In another aspect, embodiments disclosed herein relate to a method of mixing a fluid for delivery to a borehole that includes mixing a first fluid in a fluids delivery system; pumping the first fluid to the borehole through a pump at a first discharge pressure; circulating a second fluid through the fluids delivery system and the pump; and mixing a third fluid in the fluids delivery system; pumping the third fluid to the borehole through the pump at a second discharge pressure.

Other aspects and advantages will be apparent from the following description and the appended claims.

### BRIEF DESCRIPTION OF DRAWINGS

Certain embodiments will hereafter be described with reference to the accompanying drawings, wherein like reference numerals denote like elements. It should be understood, however, that the accompanying figures illustrate various implementations described herein and are not meant to limit the scope of various technologies described herein.

FIG. 1 illustrates a block diagram for a fluids mixing system, according to an embodiment.

FIG. 2 illustrates a simplified fluids mixing system, according to an embodiment.

FIG. 3 illustrates a fluids mixing system, according to an embodiment.

FIG. 4 illustrates a cross-sectional view of an example of a mixer which may be used in embodiments of the fluids mixing system, according to an embodiment.

FIG. 5 illustrates a cross-sectional view of another example of a mixer which may be used in embodiments of the fluids mixing system, according to an embodiment.

FIG. 6 illustrates a fluids mixing system, according to an embodiment.

FIG. 7 illustrates a fluids mixing system, according to an embodiment.

It should be noted that some details of the figures have been simplified and are drawn to facilitate understanding of the embodiments rather than to maintain strict structural accuracy, detail and scale.

### DETAILED DESCRIPTION

Reference will now be made in detail to embodiments of the present disclosure, examples of which are illustrated in the accompanying drawings. In the drawings and the following description, like reference numerals are used to designate like elements, where convenient. It will be appreciated that the following description is not intended to exhaustively show all examples, but is merely exemplary.

The well construction process requires multiple fluids to be mixed or modified at the wellsite. Specifically, for cased wells, the well construction process at least includes a drilling fluid and a cementing fluid. For each fluid, the basic mixing operation includes adding dry and/or liquid chemical components to a base fluid, which could be water, brine, oleaginous fluids, emulsions thereof, or an existing base mud. In existing rig architectures, the mixing systems and processes for drilling fluids and cementing fluids, for example, are kept entirely separate from each other. Both of these mixing processes are manually controlled. The result is multiple mixing systems present at the rig, with one always underutilized, given that drilling and cementing occur sequentially at a wellsite. However, the core technologies for mixing a base fluid with dry and/or liquid components are similar regardless of the application. Further, the lack of process control and automation can result in frequent variations in fluid properties due to human operator error, which can lead to negative effects in drilling performance, loss circulation control, and well integrity. There may also be a financial loss associated with these negative effects, either through non-productive time, excessive materials consumption, or inefficient drilling performance. Current training for fluid mixing operations is time-intensive, highly skilled, and difficult to cross-train. There may also be financial benefits to consolidating the mixing and modification of all fluids consumed by the well construction process into a single mixing system.

Embodiments of the present disclosure generally relate to providing an integrated fluids delivery system which provides a single mixing system for the preparation of multiple types of fluids (or any fluid) used by a rig at any stage in the well construction process, including both drilling fluids and cement fluids. In one or more embodiments, the fluids delivery system may deliver both dry and liquid components for mixing all wellbore fluids such as, but not limited to, water-based mud, oil-based mud, cement, spacer fluids, chemical washes, completion fluids, displacement fluids, viscous sweeps, loss circulation treatments, and pills for well kill operations. Also provided are embodiments of a method for operating the integrated fluids delivery system for supplying a fluid at a wellsite in an oilfield operation. Also provided may be a controls system which may automate fluids mixing and delivery through process control.

The integrated fluids delivery system may provide pressurized circulation from any or all storage tanks on the wellsite, and provide direct pressurized flow to a suction inlet of one or more high pressure pumps on the rig (to deliver the fluid downhole). Embodiments will also provide automated mixing based on the output of sensors incorporated around the system, including density, flow rate, viscosity, pH, and others. The mixing can be automated to respond to the readings from the sensors without human direction, or to modify fluids based on human input, such as laboratory test results. The integrated fluids delivery system may be composed of a combination of a dry component delivery system, fiber feeders, a liquid additive system, a series of tanks, low pressure pumps, a mixing system, and a controls system integrated into the rig network for automated and remote control.

As described, different types of fluid may be present within (and pumped into) the borehole depending on what stage of the operation is in effect. However, these fluids serve entirely different purposes. For example, mud is circulated through the borehole with the purpose of lubricating, cooling, and furthering the advancement of the drill bit. On the other hand, cement is introduced to the borehole with the purpose of stabilizing the borehole casing in a secure and final position (as well as a remedy in the event of lost circulation). Thus, the introduction of either of these fluids at the wrong time may be of dire consequence to the proper completion of the well. For example, the presence of about 1%-3% mud at a location for cementing may prevent the cement slurry from setting and forming a proper bond between the borehole casing and the wall of the borehole at that location. On the other hand, cement contaminants within the mud during drilling may impede drilling and stop the advancement of borehole casing altogether. Either of these circumstances are likely to have severe consequences, perhaps requiring a shutdown of the entire operation for re-drilling at a new location, likely at a cost of several hundred thousand dollars if not more.

Given the potential catastrophic consequences of cement slurry or mud contamination at the improper stage of well completion, conventional mud mixing assemblies and the cement mixing assemblies are separately maintained and isolated from one another on the rig. Thus, the mud mixing assembly, operating 90%-97% of the time during active drilling operations, is operated from one location on the rig. When the time for cementing approaches, mud mixing is terminated, and from a separate cementing room of the rig, the cement mixing assembly is operated. While understandable in light of the potential consequences of contamination as described above, this maintenance of entirely separate assemblies and associated equipment comes at a significant cost to already scarce footspace.

The integration of the mud and cement mixing systems will provide equipment to mix and deliver both mud and cement downhole in a single system such that a single equipment and service provider may be used for both operations, with a reduced risk of contamination. In some embodiments, the integrated equipment may include a mixing system, a liquid additive system, a bulk storage system, and controls architecture, all of which may be utilized in most of the well operations.

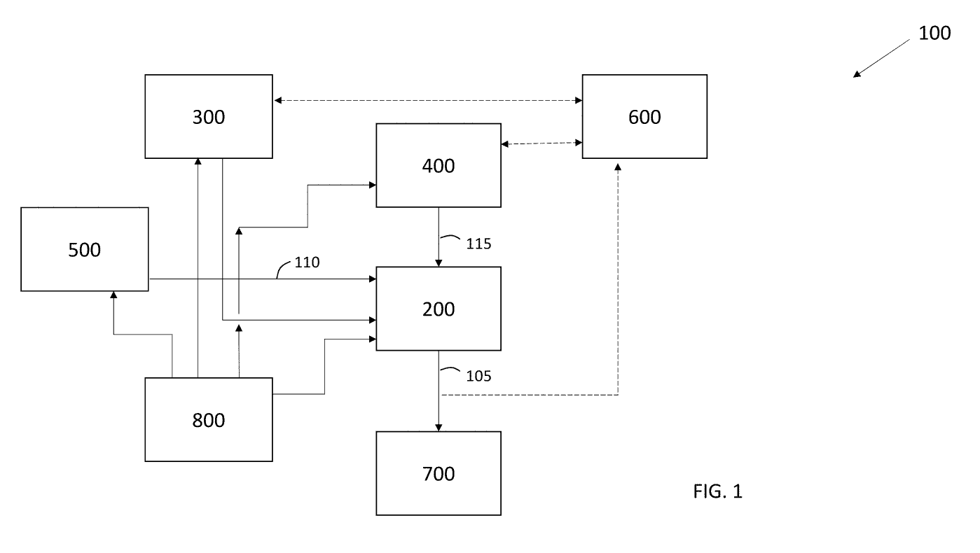

Referring now to FIG. 1, an integrated fluids delivery system 100 includes a mixing system 200, a dry component system 300, a liquid additive system 400, one or more base fluid tanks 500, and a controls system 600. The mixing system 200 will receive base fluid from tank 500, dry components from the dry component system 300 via flow line 110 and liquid additive components from the liquid additive system 400 via flow line 115. The mixing system 200 may send a wellbore fluid to a pumping system 700 via flow line 105. The pumping system 700 delivers the wellbore fluid downhole. In some embodiments, a cleaning system 800 may be fluidly connected to the mixing system 200, the dry component system 300, and the liquid additive system 400 to provide for cleaning of all the components of the systems. The controls system 600 may be coupled to the mixing system 200, the dry component system 300, and the liquid additive system 400 for formulation of the wellbore fluids, as well as the cleaning system 800 and the pumping system 700, to for full integration of the fluids delivery system 100 and delivery of the wellbore fluids downhole for sequential wellbore operations.

The integrated fluids delivery system 100 may work in conjunction with the pumping system 700 and may at least replace a dedicated cementing unit at any time during typical well construction. The integrated fluids delivery system 100 could also potentially replace mud mixing as a batch process by instead performing rapid mud mixing on the fly. As a result, the integrated fluids delivery system 100 could also remove dedicated batch mixing systems on the rig, such as a pre-mix skid or a pill tank skid. The integrated fluids delivery system 100 may include one or multiple interconnected skids for either land or offshore operations including mobile or stationary platforms.

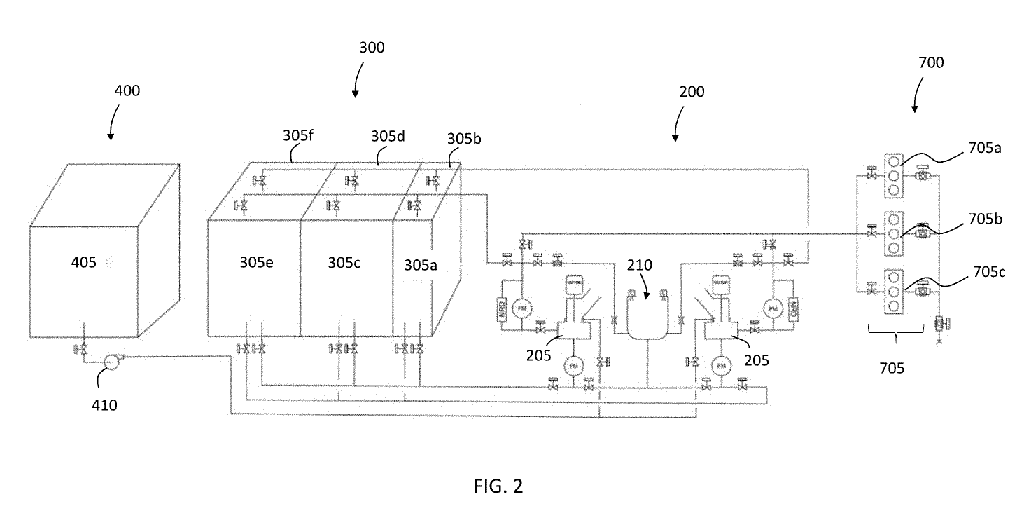

The mixing system 200 facilitates mixing of a slurry, e.g. a cement slurry, a drilling fluid, or other wellbore fluids for use in a wellbore application. The mixing system 200 (shown in greater detail in FIGS. 2-4 discussed herein) may include at least one mixer provided with a tank, e.g. a conical hopper, having a powder blend inlet, a mixing liquid inlet, and a slurry discharge. The slurry discharge may be positioned generally beneath the tank. A mixing assembly is also positioned below the tank and driven by a shaft.

The mixing system 200 mixes a slurry or fluid and directs the slurry out through a slurry discharge. Additionally, a recirculation system receives a portion of the slurry mixed in the mixing system 200 and then injects the portion back into the system 200. In some applications, the mixing system 200 may have a plurality of mixers, e.g. two mixers, used in combination to facilitate the mixing operations. It is envisioned that when a plurality of mixers are present, the plurality of mixers may mix in parallel or in sequence, depending on the arrangement of the mixing system. In particular embodiments, a plurality of mixers may be arranged sequentially such that one mixer receives all or some of the components (dry, liquid, base fluid) and provides for batching up and recirculation, and then the second mixer draws the mixed fluid out of the recirculation for pressurization to be delivered to the final destination (e.g., pumping system 700 to be pumped downhole). A flow circuit may be communicatively coupled between the mixers to facilitate control over mixing, delivery of slurry, addition of fibers or other additives, and/or solids fraction monitoring and control.

In embodiments described herein, the configuration of the mixing system 200 as well as the manner of delivering powder and mixing liquid, e.g. water, enable creation of a vortex which enhances mixing of the slurry. Creation of the vortex also enhances air separation from the slurry and release of the air through an outlet as a result of the powerful centrifugal separation enabled by the vortex. The outflow of slurry, substantially free of air, also enhances the use and accuracy of a solids fraction monitoring system which may be coupled to the controls system 600. Data provided by the solids fraction monitoring system to the controls system 600 may be used to enhance, e.g. optimize, the delivery of constituents into the mixing system 200. For example, solids fraction data can be useful for applications in which the slurry to be mixed is close to or lighter than water, e.g. applications where density measurements are not as useful.

The dry component system 300 may accommodate several dry additives for mixing mud from scratch, and modifying mud on the fly in the active system. The dry component system 300 may also accommodate delivery of cement, barite, bentonite, and other materials on the rig. The dry component system 300 may use mechanical conveyance (such as an auger) to provide the dry components to the mixing system 200, and in one or more embodiments, in a manner that may provide for metering/dosing of the dry components. In other embodiments, other forms of conveyance, such as, but not limited to, pneumatics or gravity feed may be used. The dry component system 300 may provide the ability to mix multiple bulk powder flows simultaneously. When a plurality of mixers are present, it is understood that the dry component system may provide dry components to each of the plurality of mixers (or only one mixer), depending on the fluid being formulated. Further, even when sequential mixers are being used, it is understood that in one or more embodiments, dry component system 300 may provide dry components to the second “pressurization” mixer, described above.

The liquid additive system 400 may accommodate a number of additives needed for the modification of drilling muds, cements, and other fluids. The liquid additive system 400 may include storage for liquid additives, either in specialized onboard tanks or in offboard totes and drums. Each liquid additive may be transported and metered to the mixing system 200. The additive could be mixed by direct injection into a stream of base fluid, or into the mixer itself, or into one or more tanks as a buffer of “mix fluid”, which may then be delivered into the mixer (before, after, or during recirculation of a fluid within the mixer). This process of creating “mix fluid” may be a batch or on-the-fly process.

The controls system 600 for the integrated fluids delivery system 100 allows for the automation of mechanical activities associated with mixing, as well as the human control required by current systems. The controls system 600 may control all systems mentioned above, and be able to mix either in batch process or on-the-fly, either prescriptive to a specific recipe or diagnostic to closed loop conditioning with sensor feedback. The controls system 600 may be integrated into the rig controls system, so the human control elements may be run from a remote location which could either be a workstation on another area of the well site, or in a distant location. The controls system 600 status and performance, sensor readings, and other relevant data will be consolidated into the rig database system for further analysis efforts.

The controls system 600 may be mixing fluids interchangeably which will have a varying degree of chemical incompatibility, such as cement and oil-based mud. The controls system 600 may mitigate this risk through an automated wash up cycle via the cleaning system 800, which may remove existing fluid in the system with water or another buffer solution in a predetermined process. The controls system 600 system may also include a sensor for determining the “cleanliness” of the water or buffer solution in the system, either through electrical conductivity or other means.

In some embodiments, a single operator may direct well operations from a single location at the integrated fluids delivery system 100, thus efficiently streamlining operator interfacing with the mixing system 200, the dry additive system, the liquid additive system 400, the pumping system 700 and the cleaning system 800. In some embodiments, the controls system 600 may be located at the drilling site, at the terminals on the units, or may be located remotely, such as at the driller's cabin, with all locations having emergency stop capability. In some embodiments, the controls system 600 may be integrated into the rig controls system. In some embodiments, the controls system 600 may operate the equipment either manually or under automated control. In some embodiments, a single operator may direct well completion operations from a single location, thus efficiently streamlining operator interfacing with the integrated fluids delivery system 100. In some embodiments, the controls system 600 provides a command center which houses a master computer, communication equipment, and video monitors.

In some embodiments, the integrated fluids delivery system 100 may include multiple subsystems which may provide for automatic control of fluid pressure, fluid rate, fluid density, recirculating fluid pressure, and downhole pump rate. The integrated fluids delivery system 100 may be controlled locally or remotely for well operations from a local remote HMI. During operations, the integrated fluids delivery system 100 may become active on an HMI screen for control. Each subsystem operates independently but in response to control from the controls system 600. The mixing system 200, the dry component system 300, the liquid additive system 400, the controls system 600, the pumping system 700 and the cleaning system 800 may include automatic combined and interrelated density and pumping control and selectable sequential control of predetermined mixing and pumping stages. At least to the mixing system 200, the dry component system 300, the liquid additive system 400, the controls system 600, the pumping system 700 and the cleaning system 800, the controls system 600 generates control signals interrelated by set points entered by an operator through an operator interface panel or HMI connected to the controls system 600. The controls system 600 also provides set point control signals to the fluid pressure and the recirculating fluid pressure control subsystems. The subsystems may function separately to simplify the control to single-input, single-output control loops that provide a more fault tolerant system.

In some embodiments, specific conditions which may be automatically controlled include fluid rate, fluid pressure, fluid density, recirculating fluid pressure and downhole pump rate. Each of these conditions may be the subject of a respective control loop that operates independently, but under control from controls system 600. The controls system 600 generates interrelated inlet fluid, inlet dry additives and outlet downhole pumping control signals responsive to operated-entered desired operating characteristics.

In some embodiments, the controls system 600 may be used to automate and manage the flow of fluid between the integrated fluids delivery system 100 and the pumping assembly 700 to the borehole and/or disposal. The controls system 600 may allow for the full integration of fluid operations with the drilling rig operations. In some embodiments, an industrial network (such as Modbus TCP, Profibus, Profinet, etc.) with defined data arrangements may connect the fluid system network into the rig control network. The connection may be either a direct connection of through the use of one or more intermediate translation devices.

The integrated fluids delivery system 100 may include various flowmeters, sensors, etc. such that the controls system 600 may be programmed to manage the flow between the mixing system 200, the dry component system 300, the liquid additive system 400, the pumping system 700 and the cleaning system 800 and changes between the operation of each. The controls system 600 may also be programmed to identify equipment within the integrated fluids delivery system 100. The controls system 600 may also be programmed to isolate equipment within the integrated fluids delivery system 100, such that contamination may be limited. The controls system 600 may also be programmed to provide an automatic equipment cleaning cycle within the integrated fluids delivery system 100, and combinations thereof such that contamination may be limited.

The pumping system 700 may include multiple pumps which may be integrated or coupled to each other and/or the mixing system 200, such that the pumps may be used with a cement slurry, a mud, or water. The pumps may be easily connected into the integrated fluids delivery system 100, including piping, power and computer network.

In some embodiments, the cleaning system 800 is provided to circulate water (and/or cleaning solution) throughout the integrated fluids delivery system 100. The water may be circulated from the cleaning system 800 through the mixing system 200, the dry component system 300, the liquid additive system 400, tank(s) 500, and the pumping system 700, including all the piping and manifolds. The flow of water is used to clean the equipment located therein.

Referring to FIG. 2, a simplified embodiment of the integrated fluids delivery system 100 may include the mixing system 200, the dry component system 300, the liquid additive system 400, and the pumping system 700.

The mixing system 200 may include at least two mixers 205 and a buffer tank 210. In one or more embodiments, the mixers 205 may be either an eductor style or a vortex style mixer. If the mixer 205 is an eductor style mixer, the mixer may include one or more pressurized pumps and a vortex air separator. In one or more embodiments, each mixer 205 may work in parallel, feeding a slurry/wellbore fluid into buffer (or mixing) tank 210. However, in other embodiments, one of the two mixers 205 may feed slurry into buffer tank 210 (and circulate the slurry therethrough for mixing purposes) whereas the second of the two mixers 205 may draw mixed slurry out of buffer tank 210, pressurizing the slurry in anticipation of delivering the mixed fluid downhole (or otherwise to a destination).

The dry component system 300 may include a number of storage containers 305, which can be filled with products either pneumatically from one or more pressurized silos or by cutting big bags which may be stored on pallets at the wellsite. The dry component system 300 may accommodate several dry additives for mixing mud from scratch, modifying mud on the fly in the active system, and mixing cement. The storage containers 305 (305a-305f) may contain load cells, level sensors, or other means of measuring stored inventory which may be connected to the controls system 500. The storage containers 305 may use mechanical conveyance to the point of mixing, allowing for progressive metering of dry components into the fluids being mixed in the mixers 205. In other embodiments, another form of conveyance, such as pneumatics or gravity feed may be used to deliver dry components to the mixers 205. The dry component system 300 may provide the ability to mix multiple bulk powder flows simultaneously.

In some embodiments, the liquid additive system 400 may include a tank 405 for storing the liquid needed for the mixing of drilling muds, cements, and other fluids. The liquid additive system 400 may include a pump 410 for transporting the additives to the mixers 205.

In some embodiments, after the dry components and the liquids are delivered to the mixers 205, the mixture may be recirculated through the buffer tank 210 and back to the mixers 205. The buffer tanks 210 may function as an averaging tank, for consistent control of fluid properties, and may or may not be bypassed for direct fluid feed to the pumping system 700. In some embodiments, there may or may not be additional tanks present for batching larger fluid volumes for specialized purposes, such as pills, sweeps, and kill muds.

The pumping system 700 may include one or more pumps 705. Flexibility may be achieved by having the pumping system 700 being capable of being fed cement or mud from the mixing system 200 and being able to deliver either the cement or mud to the wellbore at two different pressures, depending on the fluid being pumped.

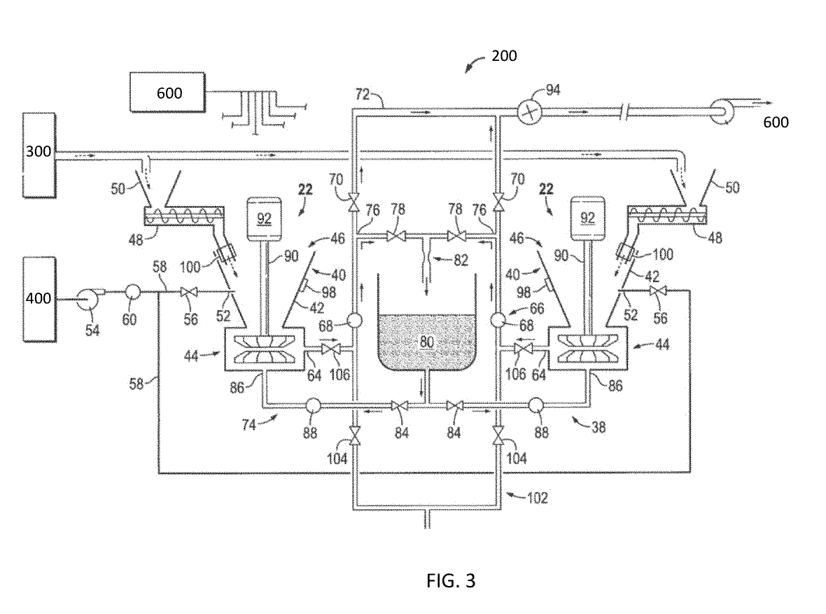

Referring to FIG. 3, a schematic illustration is provided to show an embodiment of a mixing system 200. In this embodiment, the mixing system 200 comprises a plurality of mixers 22, e.g. two mixers, coupled by a flow circuit 38. Each mixer 22 comprises a tank 40, e.g. a hopper, which may be in the form of a conical tank having a conical portion 42. The hopper/tank 40 is positioned above a mixing assembly 44 which mixes constituents to form slurry 30.

To mix the slurry 30, powder is delivered into tank 40 through a powder inlet 46 which may be located at the top or at an upper portion of tank 40. By way of example, the powder blend may be delivered to inlet 46 by a suitable powder feeder 48 or other suitable powder delivery device working in cooperation with a hopper 50 or other suitable powder receiving device. In some applications, the powder feeder 48 comprises a screw drive powder feeder operated to provide positive volumetric metering of the powder. However, other types of powder feeders 48 may be used to provide positive volumetric metering of the powder so as to enable consistent delivery of the powder.

The mixing liquid, e.g. water, also is delivered into tank 40 of each mixer 22 via a mixing liquid inlet 52. The mixing liquid may be delivered to inlet 52 by, for example, a pump 54, valves 56, and supply lines 58. A flow meter or meters 60 also may be used to facilitate monitoring and regulating of fluid flow to inlets 52 of mixers 22. By way of example, the control system 600 may connected to regulating valves 56 and/or a variable speed motor(s) driving pump 54 may be used to regulate the flow of water or other mixing liquid. The powder may be supplied by the dry component system 300 and the mixing liquid may be supplied by the liquid additive system 400, e.g. conventional supply systems, which may include a variety of pumps, tubes, tanks, conveyors, loaders, and/or other suitable material handling devices.

The liquid inlet 52 of each mixer 22 may be oriented to direct mixing liquid into tank/hopper 40 at a tangent with respect to the interior surface of the tank/hopper 40 or at another suitable angle to initiate a centrifugal action which facilitates mixing with the powder cement blend. In some applications, each liquid inlet 52 may be positioned proximate a portion of conical section 42. Additionally, the mixing liquid may be introduced between walls of a dual wall section of the conical portion 42, the dual wall section extending from an upper portion of tank 40 at least partially down toward a bottom of conical portion 42.

Once the powder and mixing liquid are mixed in each mixer 22 to form a slurry 30, the slurry is directed out through a slurry discharge 64 and into a portion of the flow circuit 38. For example, the cement slurry 30 may be discharged into a solids fraction monitoring system 66 comprising suitable sensors 68, such as non-radioactive densitometers, to enable determination and monitoring of the solids fraction in the slurry 30. The slurry 30 continues to flow through valves 70 and into a discharge line 72 which directs the slurry to pump(s) 305 of pumping system 300.

However, a portion of the slurry 30 may be directed into a recirculation system 74. The recirculation system 74 may comprise a variety of features depending on the parameters of a given mixing application. According to the illustrated embodiment, however, the recirculation system 74 comprises an inlet 76 associated with each mixer 22 and positioned to receive the recirculation portion of the slurry 30. After passing through inlet 76, the portion of the slurry 30 flows through valves 78 and into a recirculation mixing tank, e.g. buffer tank 210. By way of example, the portion of slurry 30 may pass through a restrictor 82 before entering recirculation mixing tub 80. The restrictor 82 may be used to help establish a desired back pressure which, in turn, helps to minimize air pockets, e.g. residual air bubbles, in the slurry.

From recirculation mixing tub 80, the recirculated portion of slurry 30 passes out of recirculation mixing tub 80, through corresponding valves 84, and through a passage/port 86 for injection back into mixing assembly 44. In at least some applications, the recirculated portion of slurry 30 may be flowed through a corresponding flow meter 88 before being returned into the mixing assembly 44 of the corresponding mixer 22.

The mixing assembly 44 of each mixer 22 may be powered by a variety of power sources. In the embodiment illustrated, the mixing assembly 44 of each mixer 22 is driven by a shaft 90 rotated by a corresponding motor 92, such as an electric motor. In a top drive style mixer 22, the motor is positioned above tank 40 and the shaft 90 extends down through tank 40 to mixing assembly 44. However, the mixer 22 may have other configurations, such as a bottom drive style in which the motor and shaft are disposed below the tank 40 of mixing assembly 44. In a bottom drive configuration, a seal assembly may be used to provide a seal about the shaft 90 where it passes through the mixer housing containing mixing assembly 44.

According to an embodiment, the control system 600 may be used to receive data and to control various aspects of the mixing system 200. By way of example, the control system 600 may be coupled with the dry component system 300, the liquid additive system 400, feeders 48, solids fraction monitoring system 66, flow meters 60, 88, and valves 56, 70, 78, 84 to receive data and/or to control flow along flow circuit 38. In some applications, the control system 500 may be coupled with sensors 68 of solids fraction monitoring system 66 to process the data and to determine the solids fraction of slurry 30. Based on the solids fraction of the slurry, adjustments to the flow of powder blend and/or mixing liquid may be made via control system 500.

For example, based on the data received, the control system 600 may output information to an operator and/or automatically control the amount of powder blend and/or mixing liquid delivered to each mixer 22. According to an embodiment, the control system 600 may be used to control operation of screw drive feeders 48 to provide positive volumetric metering of the dry cement blend. The control system 600 also may be used to selectively open and close valves 56, 70, 78, 84 in a manner which enables operation of individual mixers 22 or collective operation of the plurality of mixers 22. For example, control system 600 may be used to operate valves 56 and/or control pump 54 in cooperation with flow meters 60 so as to provide metering of the mixing liquid, e.g. water, introduced into each mixer 22. The control system 600 also may be utilized to control flow of slurry 30 through recirculation system 74. By way of example, control system 600 may be a computer-based control system programmable to achieve the desired mixing and delivery of cement slurry 30.

Depending on the application, mixing system 200 also may comprise various other features and components. For example, vibration components 98 may be coupled with each tank 40 to vibrate the walls of tank 40 as dry powder is delivered into each mixer 22. The vibration helps move the dry cement blend downwardly along conical portion 42 to the mixing assembly 44. By way of example, the vibration components 98 may comprise pneumatic or hydraulic vibrators mounted to, in an embodiment, an exterior surface of each tank 40.

Additionally, mass flow sensors 100, such as impact or deflection flow sensors, may be used to monitor the mass of dry blend delivered into each tank 40 via the corresponding feeder 48. The mass flow sensors 100 are coupled with control system 500 to enable very accurate monitoring of the amount of dry powder blend being introduced into each mixer 22, thus enabling a more precise control over delivery of constituents for forming the slurry 30. The control system 600 also may be used to control metering and delivery of water or other mixing fluid to ensure the desired ratio of constituents in the slurry.

In some applications, flow circuit 38 may incorporate a bypass circuit 102 for delivering other materials downhole. For example, bypass circuit 102 may be used to deliver other materials downhole via pumping system 700. According to the example illustrated, the bypass circuit 102 is ultimately coupled with discharge line 72 across valves 104. The other material introduced via bypass circuit 102 also may be flowed through sensors 68 and valves 70. Shut off valves 106 may be closed via control system 600 during use of bypass circuit 102 to ensure the other material does not enter mixers 22.

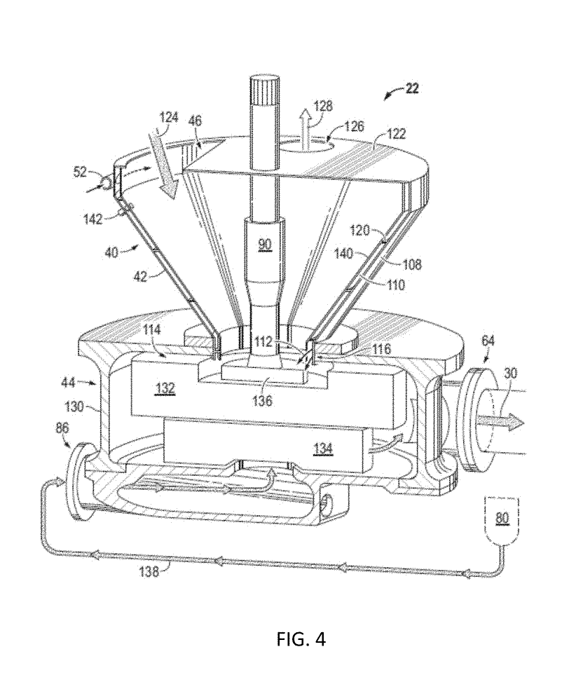

Referring to FIG. 4, an embodiment of one of the mixers 22 is illustrated. In this example, tank 40 may comprise a structure having a dual wall 108 creating an interior 110 along which the mixing liquid, represented by arrow 112, may flow in a circulating pattern, e.g. a helical pattern, before being discharged into a mixing zone 114 through a mixing liquid discharge outlet 116. It should be noted the dual wall 108 may be formed with different lengths. For example, the dual wall 108 may extend downwardly over a portion of the conical section 42, e.g. over about one half or over about three quarters of the vertical length of conical section 42. In some embodiments, the dual wall 108 terminates to provide a single wall structure at the entry region of mixing zone 114 within mixing assembly 44. Additionally, some embodiments may replace the dual wall 108 entirely with a single wall. In some embodiments, the mixing liquid 112, e.g. water, may be delivered into tank 40 via other techniques, e.g. by allowing the mixing liquid to drip or spray down from a plurality of jets arranged to effectively create a curtain of water dropping straight down into tank 40.

As illustrated, a plurality of the mixers 22, e.g. two mixers 22, may be used for redundancy. Either mixer 22 can be used individually to recirculate the slurry 30 and to pressurize the discharge line 72 toward the downstream pumping system 600. When both mixers 22 are available, the appropriate valves of flow circuit 38 may be adjusted to establish a downstream mixer 22 which can be used for the addition of fiber or other lost circulation material. This approach may keep the lost circulation material (or other dry components) out of the recirculation mixing tub 80.

According to the embodiment of FIG. 3 two mixers 22 are combined with a single recirculation mix tub 80. In this example, the mixing of slurry 30 may be achieved with one mixer 22 and the downhole pumps 305 may be pressurized with the other mixer 22. If, for example, mixing is performed at the left mixer 22, the mixing liquid, e.g. water, may be measured with flow meter 60. The flow meter may be a magnetic flow meter, but if the water is highly mineralized and at a density other than specific gravity of 1.00, a mass flow meter can be used to provide a more accurate reading of the mass flow of this stream.

The mixer 22 draws slurry out of the mixing tank 80 through the flow meter 88. This flow meter 88 can be, for example, a magnetic or mass flow meter. The mass flow of this stream is determined to facilitate calculation of mass fraction and volume fraction and therefore the density is measured. If the mixer 22 on the right side of FIG. 2 is delivering slurry to the downhole pumps 305, its discharge flows through the non-radioactive densitometer 68 illustrated on the right side of FIG. 3. This discharged fluid is the same fluid passing through the recirculating flow meter 88 so that density can be combined with the flow of the recirculating slurry to obtain its mass flow rate along with the directly measured volume flow rate. Solids are fed into the top of the mixer 22. The discharge from the mixer 22 is through the corresponding non-radioactive densitometer 68 into the mixing tank 80. Thus, mass and volume flow rates are known for three of the four flows and the mass and volume flow of solids can be calculated.

The embodiment illustrated is symmetrical and therefore redundant. If the mixer 22 illustrated on the right side of FIG. 3 cannot deliver to the downhole pumps 305, an appropriate valve may be opened to let the left mixer 22 feed the slurry 30 and also perform the mixing. If the mixer 22 illustrated on the left side of FIG. 3 cannot operate, the appropriate valves may be operated so as to switch the system to using just the right mixer 22. Using one mixer 22 may involve decreasing the flow rate. In some applications, the solids may be fed in a controlled manner by, for example, a volumetric feeder such as a large screw feeder. In some applications, pneumatic conveyance systems also can be employed for feeding the solids to the mixers 22.

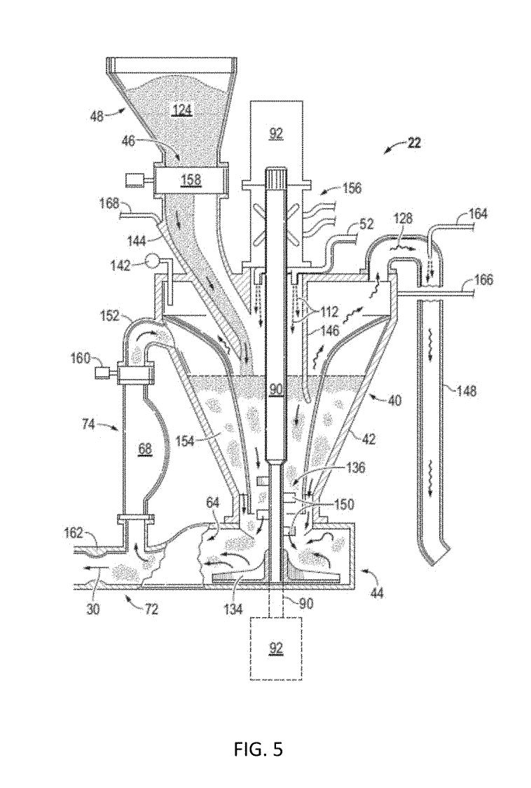

Referring to FIG. 5, another embodiment of mixer 22 is illustrated. In this example, the blend inlet 46 is positioned to deliver the dry blend 124 into tank 40 via a sealed skirt 144, e.g. an air vibrated sealed skirt. Additionally, the water inlet 52 is positioned to deliver water or other mixing fluid 112 along an interior flow path defined, for example, by a guide wall 146, e.g. a sleeve, positioned generally along shaft 90. The air 128 separated from the dry cement blend 124 and/or cement slurry may be routed out of tank 40 via an air vent housing 148. Similar to the previously described embodiment, the mixer 22 may comprise mixing assembly 44 having impeller 134 and/or slinger 132 to create the desired vortex for mixing of cement slurry constituents while also separating air. As illustrated, the mixing assembly 44 also may comprise inducer 136 which may be constructed with a series of paddles 150 coupled to shaft 90.

In this example, the slurry 30 is moved out of mixing assembly 44 through slurry discharge 64. A portion of the discharged slurry may be routed through recirculation system 74 and through a corresponding sensor 68, e.g. a non-radioactive density sensor, which may be coupled with control system 500. In this embodiment, the recirculated portion of the slurry 30 is flowed back into tank 40 via a tank inlet 152, e.g. a tangential entry inlet, positioned toward an upper region of the tank 40. The recirculated portion is then routed down through a corresponding chamber or chambers 154 and back into mixing chamber 44 as illustrated.

In the embodiment illustrated in FIG. 5, various other and/or additional features may be incorporated into the overall system. For example, the mixer motor 92 may be cooled by a cooling system 156, e.g. a liquid cooling system routing cooling fluid through a motor coolant housing. Additionally, this embodiment and other embodiments may be powered by motor 92 arranged in a top drive configuration, as illustrated by solid lines, or in a bottom drive configuration, as illustrated by dashed lines.

Examples of other features comprise a quick shutoff 158 positioned to enable rapid shut off of powder blend 124 at inlet 46. A valve or valves 160 may be positioned along recirculation system 74 so as to enable control over flow, e.g. shut off of flow, along the recirculation system. A flow restrictor 162 may be used to establish back pressure for ensuring a desired flow through recirculation system 74 as well as compression of air bubbles. In some applications, a mist vent 164 may be positioned along air vent housing 148 to control dust that may be carried by the airflow 128. Similarly, cleanup vents 166, 168 may be positioned to deliver a cleaning liquid, e.g. water, to an interior of tank 40 and an interior of sealed skirt 144, respectively. The vents 166, 168 may be used to deliver liquid which cleans unwanted material from the corresponding interior surfaces.

The system and methodologies described herein also may be employed in non-well related applications in which slurries or other mixtures are prepared. For example, the mixer 22 may be used to mix a variety of other types of slurries and/or fluid mixtures. Embodiments of the mixer 22 also may be utilized in batch mixing systems. Additionally, the size and configuration of components used to construct each mixer 22 and mixing system 200 may be adjusted according to the parameters of a given application and/or environment. In some applications, various other and/or additional sensors may be incorporated throughout the flow circuit. The content of the slurry constituents, e.g. solids and liquids, may be adjusted according to the parameters of a given cementing application.

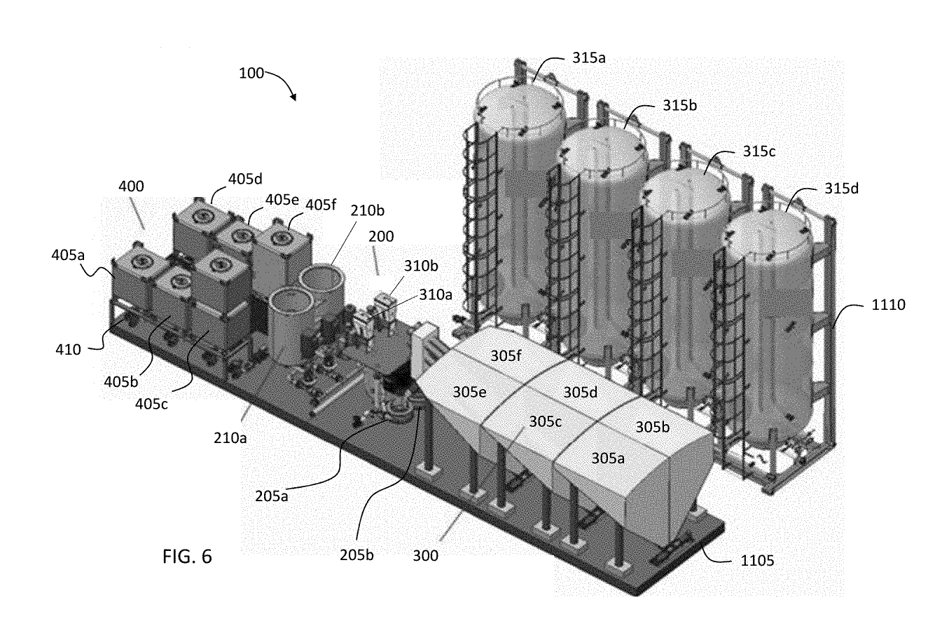

Referring to FIG. 6, an embodiment of the integrated fluids delivery system 100 may include a skid 1105 having the mixing system 200, the dry component system 300, and the liquid additive system 400 located thereon.

The mixing system 200 may include at least two mixers 205, one or more pumps 215, and one or more buffer tanks 210. The mixers 205 may be either an eductor style or a vortex style mixer. If the mixer 205 is an eductor style mixer, the mixer may include one or more pressurized pumps and a vortex air separator. In some embodiments, the mixers 205 may be such as that described for FIGS. 4 and 5 for mixers 22. In some embodiments, multiple pumps 215 may be used to deliver liquids from the buffer tanks 210 to the mixers 205. The mixing system 200 may include one or more of a non-radioactive densitometer, a flow meter, an inline rheometer, a pH meter, or other sensors which may be connected to the controls system 500 or may include those described above in FIGS. 3-5. The buffer tanks 210 may function as an averaging tank, for consistent control of fluid properties, and may or may not be bypassed for direct fluid feed to the pumping system (not separately shown). In some embodiments, there may or may not be additional tanks present for batching larger fluid volumes for specialized purposes, such as pills, sweeps, and kill muds.

The dry component system 300 may include a number of storage containers 305, which can be filled with products either pneumatically from one or more pressurized silos 315, or by cutting big bags which may be stored on pallets at the wellsite. The dry component system 300 may accommodate several dry additives for mixing mud from scratch, and modifying mud on the fly in the active system, and/or mixing cement from storage containers 305 and/or pressurized silos 315 (direct or via storage containers 305). The storage containers 305 may contain load cells, level sensors, or other means of measuring stored inventory which may be connected to the controls system 500. The storage containers 305 may use mechanical conveyance to the point of mixing, allowing for progressive metering of dry components into the fluids being mixed in the mixers 205. In other embodiments, another form of conveyance, such as pneumatics or gravity feed may be used to deliver dry components to the mixers 205. The dry component system 300 may provide the ability to mix multiple bulk powder flows simultaneously. In some embodiments, the dry component system 300 may also include one or more fiber feeders 310 for the automatic addition of fibers, or other loss circulation materials directly to the point of mixing.

In some embodiments, the storage containers 305 may include auger cans on load cells which can be loaded pneumatically. In some embodiments, the storage containers 305 with augers may have dual motors with overrunning clutches to prevent single point of failure. The storage containers 305 may be dedicated for dry components for either mixing mud or concrete, thus eliminating the likelihood of contamination.

In some embodiments, the dry component system 300 may also include one or more silos 315 for loading dry components to the storage containers 305 or sending the dry components directly to the mixers 205. In some embodiments, the silos 315 may be located on a separate skid 1110. In other embodiments, the silos 315 may be located on skid 1105 or each silo may have its own skid.

In some embodiments, the liquid additive system 400 may include a number of bins 405 for storing the additives needed for the modification of drilling muds, cements, and other fluids. The liquid additive system 400 may include one or more pumps 410 for transporting the additives to the buffer tanks 210. Each liquid additive may be transported and metered to the buffer tanks 210. The pumps 410 may also be used to onboard fluids and deliver them within the skid 1105 and also bypass the buffer tanks 210. The liquid additive system 400 may include one or more of a non-radioactive densitometer, a flow meter, an inline rheometer, a pH meter, or other sensors which may be connected to the controls system 600. In some embodiments, there may or may not be additional bins present for batching larger fluid volumes for specialized purposes, such as pills, sweeps, and kill muds.

Flexibility in the integrated fluids delivery system 100 may be found by having the mixing system 200 being able to deliver either the cement or mud (or other wellbore fluid) to the pumping system (not separately shown). The flexibility may also be achieved by having the pumping system being capable of being fed cement or mud from the mixing system 200 and being able to deliver either the cement or mud to the wellbore at two different pressures, depending on the fluid being pumped. By having the cleaning system (not separately shown) provide water to the mixing system 200 and the pumping system (not separately shown), the mixers and pumps may be cleaned to limit the risk of contamination between the mixers, the pumps and associated equipment and piping. In some embodiments, the cleaning system may also provide water to the dry additive system 300 and the liquid additive system 400, providing water to all equipment located therein. Isolation between the mixing system 200, the dry additive system 300, the liquid additive system 400 and the pumping system may be provided by numerous valves which may limit the risk of contamination between the systems.

The integrated fluids delivery system 100, specifically the ends of the electrical lines, hydraulic lines and/or pneumatic lines, and the equipment located therein may have plug-and-play connections, such as, for example but not limited to, those sold by Parker Hannifin Corp. (Minneapolis, Minn.) or Stucchi USA Inc., Romeoville, Ill. The plug-and-play connections may connect the electrical lines, the hydraulic lines and/or the pneumatic lines from the integrated fluids delivery system 100 to the mixing system 200, the dry additive system, the liquid additive system 400, the controls system 600, the pumping system 700 and the cleaning system 800. A centralized engine located within the integrated fluids delivery system 100 may supply power to the equipment located within the mixing system 200, the dry additive system, the liquid additive system 400, the controls system 600, the pumping system 700 and the cleaning system 800. The plug-and-play connections may be integrated into the mixing system 200, the dry additive system, the liquid additive system 400, the controls system 600, the pumping system 700 and the cleaning system 800, and the equipment located therein may be provided with universal terminals so that when plugged into each other, the terminals will make a proper connection, such as a power, a hydraulic or a pneumatic connection, between a central source, including a central electricity line, a central hydraulic line and/or a central pneumatic line, and the equipment.

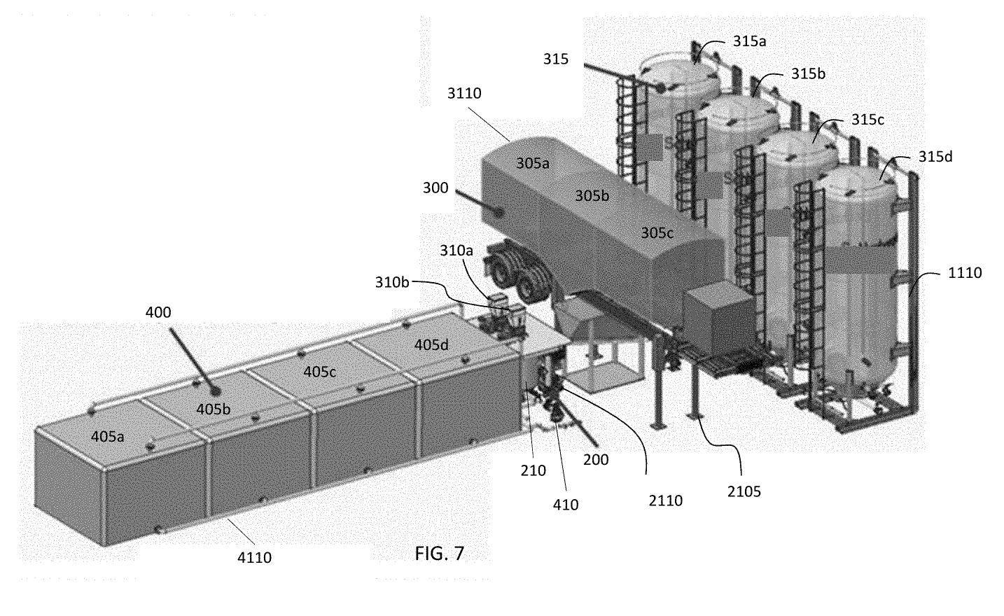

Referring to FIG. 7, an embodiment of the integrated fluids delivery system 100 may include dry component system 300 having a trailer lift 2105 with a trailer 3110 located thereon. The trailer 3110 may be filled with products either pneumatically from one or more pressurized silos 315 (illustrated as 315a-d) or may be driven on-site with product therein. The trailer 3110 may have one or more bins 305 (illustrated as 305a-c) located therein. The bins 305 may be filled up pneumatically either in batches or on-the-fly. Under the trailer 3110, a conveyor auger can receive material product from any of the bins 305 and deliver the material to the mixing system 200. The trailer 3110 may have dual compressors able to deliver higher rates together (to match auger delivery rates) but also to deliver at reduced rates if one fails. In some embodiments, the bins 315 may be dedicated to components for either drilling product or cement. The trailer 3110 may contain load cells, level sensors, or other means of measuring stored inventory which may be connected to the controls system. In some embodiments, the trailer 3110 may include a dust collection system (not shown).

The mixing system 200 may be located on a mixing skid 2110, separate from the trailer 3110. Manifolds may be located on either side of the skid 2110. The liquid additive system 400 of the integrated fluids delivery system 100 of FIG. 7 may include one or more bins 405 located on a separate skid 4110. In other embodiments, the liquid additive system 400 and the mixing system 200 may be on the same skid. The liquid additive system 400 may include one or more pumps 410 for transporting the additives to the buffer tanks 210. Each liquid additive may be transported and metered to the buffer tanks 210. The pumps 410 may also be used to onboard fluids and deliver them within the skid 4110 and also bypass the buffer tanks 210.

Referring back to FIG. 2, the pumping system 700 may include one or more pumps 705. In some embodiments, the first pump 705a and the second pump 705b are sized to maintain consistent flow of mud downhole. The first pump 705a, the second pump 705b, and the third pump 705c have various pieces of equipment, including sensors and controllers, for monitoring the flow and composition of the mud being pumped downhole and also being returned for recycling. In some embodiments, redundancy may be provided by having the first pump 705a, the second pump 705b, and the third pump 705c equally sized so that if for some reason one of the pumps is unable to complete the drilling operation, the other pump(s) may be put into operation to complete the drilling. Thus, the pumps 705 may have duality for pumping mud and/or cement, by being sized and piped to accommodate both wellbore fluids.

Valving may be manipulated to ensure drilling fluid flows from the mixing assembly 200 to the pumping system 700. The pumps 705 are sized and designed to provide various fluids to the well at different pressures. In some embodiments, the pumps 705 are designed to pump a first fluid ranging from about 3000 kPa to about 50000 kPa, or from about 3400 kPa to about 49000 kPa. In other embodiments, the pumps 705 are designed to pump a second fluid ranging from about 3000 kPa to about 70000 kPa, or 3400 kPa to 69000 kPa.

Drilling while employing circulating mud provides lubrication and a degree of cooling to a grinding bit. The circulation of the mud also allows for the removal of cuttings and debris as the borehole extends deeper below the floor. In some embodiments, the mud circulation and drilling are directed from the control system 600. Once a given depth of the borehole has been reached, the control system 600 may be employed to cease the indicated circulation of mud and retract the drilling pipe. Thus, cementing of a section of borehole casing may ensue. The control system 600 may also be used in directing the subsequent cementing application. In some embodiments, the control system 600 may control the operation of the mixing system 200, the dry additive system 300, the liquid additive system 400, the pumping system 700, and the cleaning system 800.

In some embodiments, the control system 600 is remote from the integrated fluids system 100. In other embodiments, components of the control system 600 may be located on or near the integrated fluids system 100.

The control system 600 may also collect data from a variety of sensors located throughout the integrated fluids system 100. Based on this data the control system 600 may be used to control the mud pumping and the cementing operations. The data from the control system 600 may be transferred to a rig network. In some embodiments, addresses within the rig network may be sent to a spreadsheet for correlating data for operation of the integrated fluids system 100. The addresses may include status (read only) tags, data tags and control tags. In some embodiments, additional addresses may be included for additional data.

In some embodiments, such as during the mud operation, the driller may control the pumping system 700. In other embodiments, the rig may control the pumping system 700 during mud operations. The control may be switched between the rig and the driller.

In some embodiments, the integrated fluids system 100 may control the operation of the mixing system 200, the dry additive system 300, the liquid additive system 400, and the pumping system 700. Based on the data collected by the control unit, the control system 600 may modify the mud composition or the cement composition. The control system 600 may also control when the integrated fluids system 100 switches from pumping mud to pumping cement. The control system 600 may also control the cleaning system 800 such that the integrated fluids system 100 is cleaned when switching between mud and cement operations.

In one or more exemplary embodiments, the control system 600 may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the present teachings have been illustrated with respect to one or more embodiments, alterations and/or modifications may be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the illustrated embodiment. Finally, “exemplary” indicates the description is used as an example, rather than implying that it is an ideal.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

What is claimed is:

1. A fluids delivery system comprising:
a mixing system configured to deliver a fluid to a wellbore;
a dry component delivery system configured to deliver a dry component to the mixing system;
a liquid additive system configured to deliver a liquid component to the mixing system; and
a controls system configured to control the mixing system, the dry additive system and the liquid additive system to produce the fluid.

2. The fluids delivery system of claim 1, wherein the mixing system comprises at least two mixers, a sensor array, and a buffer tank.

3. The fluids delivery system of claim 1, wherein the dry component delivery system comprises at least one dry storage container.

4. The fluids delivery system of claim 3, wherein the dry component delivery system further comprises a measuring component to measure the inventory of the at least one dry storage container.

5. The fluids delivery system of claim 3, wherein the dry component delivery system further comprises at least one of a gravity conveyance, a pneumatic conveyance, or a mechanical conveyance to deliver the dry component to the mixing system.

6. The fluids delivery system of claim 1, further comprising at least one fiber feeder.

7. The fluids delivery system of claim 1, wherein the liquid additive system comprises at least one liquid storage container.

8. The fluids delivery system of claim 7, wherein the liquid additive system further comprises a pump to deliver the liquid additive to the mixing system.

9. The fluids delivery system of claim 2, wherein the controls system is configured for receiving output from the sensor array and adjusting conditions of at least one of the dry component delivery system, the liquid additive system, and the mixing system.

10. The fluids delivery system of claim 1 being located on a skid.

11. The fluids delivery system of claim 1, wherein the dry component delivery system is located on a mobile trailer.

12. The fluids delivery system of claim 1, wherein the fluid is selected from the group consisting of water-based mud, oil-based mud, cement, spacer fluids, chemical washes, brines, displacement fluids, viscous sweeps, loss circulation treatments, and pills for well kill operations.

13. The fluids delivery system of claim 1, further comprising a cleaning system configured to circulate a cleaning solution throughout the integrated fluids delivery system.

14. A method of mixing a fluid for delivery to a borehole, the method comprising:
mixing a first fluid in a fluids delivery system;
pumping the first fluid to the borehole through a pump at a first discharge pressure;
circulating a second fluid through the fluids delivery system and the pump; and
mixing a third fluid in the fluids delivery system;
pumping the third fluid to the borehole through the pump at a second discharge pressure.

15. The method of claim 14, further comprising:
controlling with a computer, the mixing of the first fluid, the circulating of the second fluid, and the mixing of the third fluid; and
sequentially performing said controlling step for the fluid so that the first fluid and the third fluid are sequentially placed in the well by a single pump.

16. The method of claim 15, further comprising controlling, with the computer, a flow of a liquid component into a mixing assembly, a flow of dry solids into the mixing assembly, to produce either the first fluid or the third fluid.

17. The method of claim 15, wherein the controlling comprises controlling density, yield, mix rate, water volume and total volume data for either the first fluid and the third fluid.

18. The method of claim 17, wherein said sequentially performing includes automatically switching from one controlling step using a first respective set of the data to another controlling step using a second respective set of the data.

19. The method of claim 18, further comprising changing at least one of a plurality of operating characteristics during the sequentially performing step and changing at least one of the flow of liquid into the mixing assembly, the flow of dry solids into the mixing assembly, and the flow of resultant mixture from the mixing assembly into the well.
